(19) United States
(12) Patent Application Publication
(10) Pub. No.: US 2026/0192767 A1
(43) Pub. Date: Jul. 9, 2026

(54) VEHICLE CONTROL SYSTEM, VEHICLE CONTROL METHOD, AND NON-TRANSITORY COMPUTER-READABLE STORAGE MEDIUM

(71) Applicant: HONDA MOTOR CO., LTD., Tokyo (JP)

(72) Inventors: Keita AKIHO, Tokyo (JP); Kenyu OKAMURA, Tokyo (JP); Hisaki SUGAYA, Tokyo (JP); Fan ZHANG, Tokyo (JP); Masaki ANKAI, Tokyo (JP)

(21) Appl. No.: 19/423,246

(22) Filed: Dec. 17, 2025

(30) Foreign Application Priority Data
Jan. 8, 2025 (JP) 2025-002638

(51) Int. Cl. B60R 21/0132; B60R 21/0134; B60R 21/01; B60R 21/013

(52) U.S. Cl. CPC B60R 21/0132; B60R 21/0134; B60R 2021/01013; B60R 2021/01231; B60R 2021/01304; B60R 2021/01322

(57) ABSTRACT

A vehicle control system including: an obstacle recognizer configured to recognize an obstacle around a vehicle based on a signal from a radar; an acceleration detector configured to detect acceleration of the vehicle based on a signal from an acceleration sensor; a collision predictor configured to determine a possibility of collision between the obstacle and the vehicle; and an airbag controller configured to deploy an airbag provided in the vehicle when the acceleration is equal to or greater than a deployment threshold. The airbag controller lowers the deployment threshold when a time period during which the obstacle recognizer continuously detects the obstacle is equal to or longer than a capture threshold and the collision predictor determines that the possibility of the collision between the obstacle and the vehicle is present.

### TECHNICAL FIELD

The present invention relates to a vehicle control system, a vehicle control method, and a non-transitory computer-readable storage medium.

### BACKGROUND ART

In recent years, efforts have been actively made to provide sustainable transport systems that take into account people in vulnerable situations among traffic participants. To achieve this, research and development on collision safety performance has been conducted to further improve safety and convenience of traffic.

JP2023-136469A discloses a vehicle control system that controls a deployment of an airbag. The vehicle control system deploys the airbag when a lateral acceleration of a vehicle exceeds a deployment threshold. The vehicle control system predicts a future position of the vehicle and a future position of a target, and predicts whether the target collides with a side surface of the vehicle based on the future positions of the vehicle and the target. The vehicle control system then lowers the deployment threshold when the target is predicted to collide with the side surface of the vehicle. Accordingly, the airbag is deployed earlier.

A radar may be used to detect the positions of the vehicle and the obstacle. However, the radar may experience a ghost phenomenon in which an obstacle that does not actually exist is detected due to multipath reflection of radio waves. In a case where the deployment threshold of the airbag is lowered based on the obstacle that does not actually exist, the acceleration caused by an unevenness of a road surface may exceed the deployment threshold, resulting in the airbag being deployed at an undesirable timing.

### SUMMARY OF THE INVENTION

In view of the above background, an object of the present invention is to provide a vehicle control system, a vehicle control method, and a non-transitory computer-readable storage medium that can deploy an airbag at an appropriate timing.

To achieve such an object, one aspect of the present invention provides a vehicle control system including: an obstacle recognizer configured to recognize an obstacle around a vehicle based on a signal from a radar; an acceleration detector configured to detect acceleration of the vehicle based on a signal from an acceleration sensor; a collision predictor configured to determine a possibility of collision between the obstacle and the vehicle; and an airbag controller configured to deploy an airbag provided in the vehicle when the acceleration is equal to or greater than a deployment threshold, and the airbag controller lowers the deployment threshold when a time period during which the obstacle recognizer continuously detects the obstacle is equal to or longer than a capture threshold and the collision predictor determines that the possibility of the collision between the obstacle and the vehicle is present.

Another aspect of the present invention provides a vehicle control method executed by a computer, the method including: recognizing an obstacle around a vehicle based on a signal from a radar; detecting acceleration of the vehicle based on a signal from an acceleration sensor; determining a possibility of collision between the obstacle and the vehicle; deploying an airbag provided in the vehicle when the acceleration is equal to or greater than a deployment threshold; and lowering the deployment threshold when a time period during which the obstacle is continuously detected is equal to or longer than a capture threshold and the possibility of the collision between the obstacle and the vehicle is determined to be present.

Another aspect of the present invention provides a non-transitory computer-readable storage medium comprising a control program, wherein the control program, when executed by a computer, executes a vehicle control method, including: recognizing an obstacle around a vehicle based on a signal from a radar; detecting acceleration of the vehicle based on a signal from an acceleration sensor; determining a possibility of collision between the obstacle and the vehicle; deploying an airbag provided in the vehicle when the acceleration is equal to or greater than a deployment threshold; and lowering the deployment threshold when a time period during which the obstacle is continuously detected is equal to or longer than a capture threshold and the possibility of the collision between the obstacle and the vehicle is determined to be present.

Thus, according to the above aspects, it is possible to provide the vehicle control system, the vehicle control method, and a non-transitory computer-readable storage medium that can deploy the airbag at an appropriate timing.

### BRIEF DESCRIPTION OF THE DRAWING(S)

FIG. 1 is a block diagram of a vehicle control system according to an embodiment of the present invention;

FIG. 2 is an explanatory diagram of a ghost recognized by a radar;

FIG. 3 is a graph showing a deployment threshold;

FIG. 4 is a flowchart showing a procedure for setting the deployment threshold in a vehicle control method according to the embodiment; and

FIG. 5 is a flowchart showing a procedure for controlling a deployment of an airbag in the vehicle control method according to the embodiment.

### DETAILED DESCRIPTION OF THE INVENTION

In the following, embodiments of a vehicle control system, a vehicle control method, and a non-transitory computer-readable storage medium will be described with reference to the drawings.

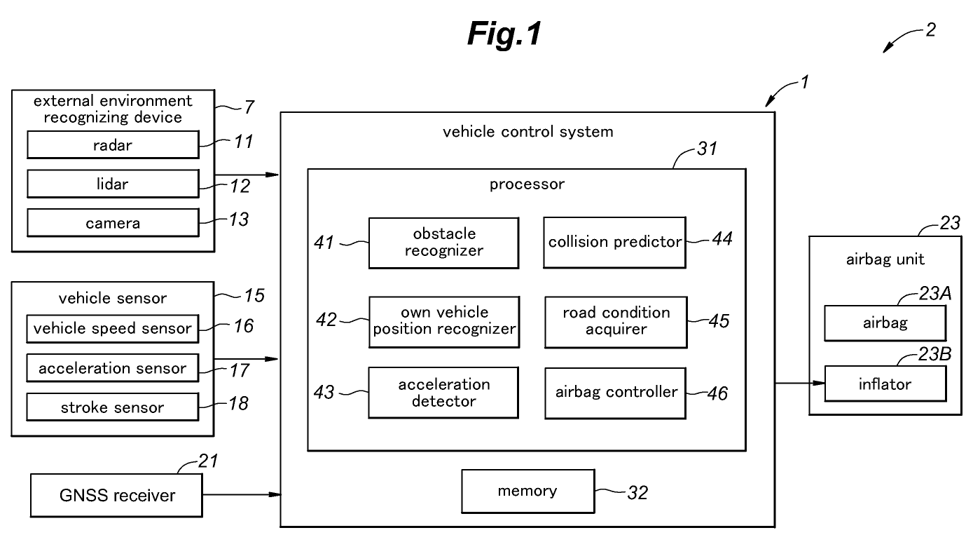

As shown in FIG. 1, a vehicle control system 1 is installed in a vehicle 2. The vehicle 2 is a four-wheeled automobile. The vehicle 2 may be an autonomous driving vehicle or a vehicle with a driving assistance function.

The vehicle 2 includes an external environment recognizing device 7. The external environment recognizing device 7 is a device for detecting objects outside the vehicle and the like. The external environment recognizing device 7 is a sensor that captures electromagnetic waves and light from the surroundings of the vehicle 2 to detect the objects outside the vehicle. The external environment recognizing device 7 includes a radar 11, a lidar 12 (LIDAR), and a camera 13.

The radar 11 transmits radio waves around the vehicle 2 and detects the position and speed of the object by receiving the radio waves reflected by the object. The radar 11 is preferably a millimeter wave radar using millimeter waves as electromagnetic waves. It is preferable that a plurality of radars 11 be provided in the vehicle 2. The radar 11 includes at least a front radar that detects objects present in the area in front of the vehicle 2. The radar 11 may include a rear radar that detects the obstacle present in the area behind the vehicle 2. The radar 11 may include a plurality of corner radars that detect obstacles present in areas located in front-right, front-left, rear-right, and rear-left directions of the vehicle 2.

The front radar, which is one of the radars 11, is preferably installed in the center of the front end of the vehicle 2 in the lateral direction, and transmits radio waves forward. The front radar may be arranged, for example, behind an emblem provided on the front end of the vehicle 2. The emblem is preferably made of a resin material that transmits radio waves. The front radar transmits radio waves at the prescribed angular range to the left and right with respect to the center line extending forward from the vehicle 2. For example, the angular range is preferably set to 20° or 15° to each of the left and right sides. For example, the front radar may transmit radio waves over a range of 30 m to each of the left and right sides at a distance of 150 m ahead of the vehicle 2. The front radar may transmit radio waves at the prescribed angular range upward and downward with respect to the center line.

The radar 11 transmits radio waves in a pulsed manner and measures the time until the reflected waves reflected by objects return. The radar 11 detects the intensity of the reflected waves and uses the directivity of the antenna to detect the angle at which the object is present. The radar 11 further measures the speed of the object using the Doppler effect based on the difference between the frequency of the reflected waves and the frequency of the transmitted waves. The radar 11 outputs the radar data including these measurements.

The lidar 12 irradiates light, such as infrared light, around the vehicle 2 and detects the position (distance and direction) of objects by capturing the reflected light. The lidar 12 may detect the obstacle present in the area in front of the vehicle 2.

The camera 13 captures images of the surroundings of the vehicle 2 and acquires images of the surroundings of the vehicle 2. The image of the surroundings of the vehicle 2 includes surrounding vehicles (surrounding moving objects), pedestrians, guardrails, curbs, walls, medians, the shape of the road, delimiting lines, road markings painted on the road, and the like that are present around the vehicle 2. The camera 13 may be, for example, a digital camera that uses a solid-state image sensor such as a CCD or CMOS. The camera 13 includes at least a front camera that captures the area in front of the vehicle 2. The camera 13 may include a rear camera that captures an image behind the vehicle 2 and a pair of side cameras that capture images on the left and right sides of the vehicle 2. The camera 13 may be, for example, a stereo camera.

The vehicle 2 includes a vehicle sensor 15. The vehicle sensor 15 includes a vehicle speed sensor 16 that detects the speed of the vehicle 2 and an acceleration sensor 17 that detects the acceleration. The vehicle sensor 15 may include a yaw rate sensor that detects the angular velocity about a vertical axis, an orientation sensor that detects the orientation of the vehicle 2, and the like. The vehicle speed sensor 16 includes four wheel speed sensors provided on the four wheels. Each wheel speed sensor detects the rotational speed of the corresponding wheel. The wheel speed sensor may be a magnetic rotary encoder constituted by, for example, a Hall element and a permanent magnet.

The acceleration sensor 17 may detect at least the acceleration of the vehicle 2 in the front-and-rear direction and the acceleration in the up-and-down direction. The acceleration sensor 17 may also detect the acceleration of the vehicle 2 in the lateral direction.

The vehicle sensor 15 may include a stroke sensor 18 capable of detecting the vertical position of each wheel relative to the vehicle body. The stroke sensor 18 is provided in a suspension device provided between the vehicle body and the wheel, extends and contracts in response to the movement of the suspension device, and outputs a signal according to the length thereof.

The vehicle 2 includes a Global Navigation Satellite System (GNSS) receiver 21. The GNSS receiver 21 identifies the position (latitude and longitude) of the vehicle 2 based on signals received from artificial satellites (positioning satellites).

The vehicle 2 includes a Human Machine Interface (HMI) 22. The HMI 22 notifies the occupant of various information by display and sound, and also accepts input operations by the occupant. The HMI 22 may include, for example, a touch panel display and a speaker.

The vehicle 2 is provided with an airbag unit 23 to protect the occupant in the event of a collision of the vehicle 2. The airbag unit 23 includes an airbag 23A and an inflator 23B that inflates the airbag 23A. The inflator 23B receives an electric signal from the vehicle control system 1 and generates inflation gas to inflate the airbag 23A. The airbag unit 23 may be provided in a steering wheel, an instrument panel, the front pillar, the middle pillar, and the rear pillar of the vehicle 2, the side portion of a seat back, and the like.

The vehicle control system 1 is a computer including a processor 31 and a memory 32 communicatively connected to the processor 31. The processor 31 may include at least one of the following cores: a central processing unit (CPU), a graphics processing unit (GPU), and a reduced instruction set computer (RISC). The memory 32 stores the control program executed by the processor 31 and various data. The memory 32 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage, or an optical disk storage. At least a portion of the vehicle control system 1 may be realized by hardware such as a large scale integration (LSI), an application specific integrated circuit (ASIC), or a field-programmable gate array (FPGA), or may be realized by a combination of software and hardware. The vehicle control system 1 may be composed of a single piece of hardware, or may be composed of plural pieces of hardware capable of communicating with each other. A portion of the vehicle control system 1 may be composed of an external server provided outside the vehicle 2.

The processor 31 realizes various applications by executing a program stored in the memory 32. The program may be stored in a removable recordable medium such as a DVD or a CD-ROM, and installed in the memory 32 as the recordable medium is read by a reading device. The program may also be downloaded and installed in the memory 32 via a communication network such as the Internet.

The map information may be stored in the memory 32. The map information may be high-precision map information. The map information contains road information which may include types of roads such as expressways, toll roads, national highways, and prefectural roads, the number of lanes in each road, the center position of each lane (three-dimensional coordinate including a longitude, a latitude, and a height), shapes of the road markings such as road delimiting lines and lane boundaries, presence or absence of sidewalks, curbs, fences and the like, positions of intersections, positions of lane-merging points and lane-branching points, areas of emergency parking zones, and the width of each lane and road signs on the roads. The map information may also contain traffic control information, address information (address, postal code), facility information, telephone number information, and the like.

By executing the programs stored in the memory 32, the processor 31 functions as an obstacle recognizer 41, an own vehicle position recognizer 42, an acceleration detector 43, a collision predictor 44, a road condition acquirer 45, and an airbag controller 46. The memory 32 functions as a non-transitory computer-readable storage medium comprising the control program. The control program, when executed by the processor 31 of the vehicle control system 1, executes the vehicle control method.

The obstacle recognizer 41 recognizes the surrounding environment of the vehicle 2. The obstacle recognizer 41 recognizes the surrounding environment (external environment), including the obstacles located around the vehicle 2, the shapes of the roads, the presence or absence of sidewalks, road markings, and the like, based on the detection results of the external environment recognizing device 7. The obstacles include, for example, guardrails, utility poles, the surrounding vehicles, and people such as pedestrians. The obstacle recognizer 41 can acquire the position, speed, acceleration, and other states of the surrounding vehicles from the detection results of the external environment recognizing device 7.

In the present embodiment, the obstacle recognizer 41 recognizes the obstacle around the vehicle 2 based on the signal from the radar 11. The obstacle recognizer 41 acquires the position and speed of the obstacle based on the radar data. The position of the obstacle may be expressed by the distance between the vehicle 2 and the obstacle and the angle of the obstacle relative to the vehicle 2. The obstacle recognizer 41 may recognize a target whose reflected wave has an intensity equal to or greater than the prescribed value as the obstacle.

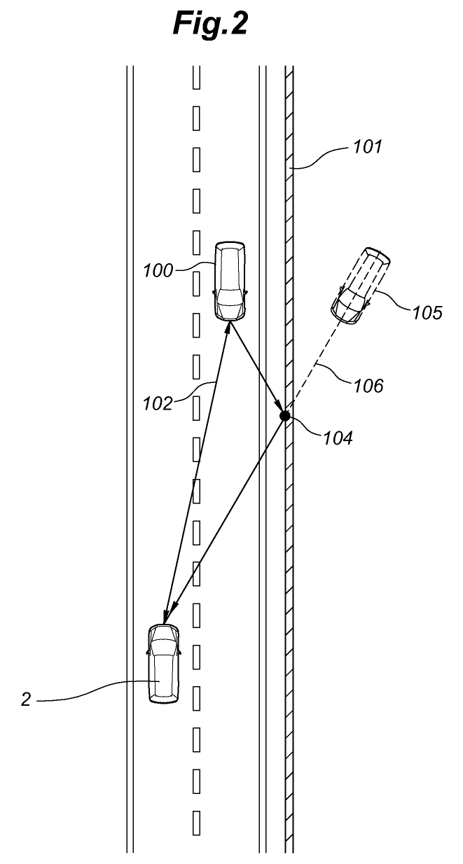

The obstacle recognizer 41 may erroneously recognize the presence of an obstacle at a position where no obstacle actually exists due to multiple reflections of the reflected waves. This phenomenon is referred to as a ghost phenomenon of the radar 11. For example, as shown in FIG. 2, in a case where a surrounding vehicle 100 exists as an obstacle ahead of the vehicle 2 and a wall 101, such as a soundproof wall, exists at the roadside, the ghost phenomenon may occur. An appropriate reflection path 102 of the radio wave is a linear path connecting the vehicle 2 and the surrounding vehicle 100. On the other hand, in a case where multiple reflections occur, the reflected wave reflected by the surrounding vehicle 100 is further reflected by the wall 101 and then received by the radar 11. In this case, since the reception direction of the reflected wave corresponds to the direction in which a reflection point 104 on the wall 101 is located, ghost 105, which is the obstacle that does not actually exist, is erroneously recognized as existing on a virtual line 106 connecting the vehicle 2 and the reflection point 104 on the wall 101. Further, the time required for the radio waves to be received becomes longer due to multiple reflections, and thus the ghost 105 is erroneously recognized as existing behind the wall 101.

The ghost 105 disappears in accordance with a change in the relative position between the obstacle and the wall 101, a change in the shape of the wall 101, or the disappearance of the wall 101. Accordingly, the ghost 105 persists for a relatively short period of time. In the present embodiment, the obstacle recognizer 41 measures the time period during which the obstacle is continuously detected. When the time period during which the obstacle is continuously detected (capture time) is equal to or longer than a capture threshold, the obstacle recognizer 41 determines that the obstacle actually exists, i.e., that the obstacle is not a ghost. The capture threshold may be, for example, 0.5 to 3.0 s, preferably 2.0 to 3.0 s.

The obstacle recognizer 41 may lower the capture threshold as the speed of the obstacle or the speed of the vehicle 2 increases. That is, in a situation where the speed of the obstacle or the vehicle 2 is high and higher safety is required, the obstacle is determined to be an actually existing obstacle at an earlier timing. The obstacle recognizer 41 may lower the capture threshold as the relative speed between the obstacle and the vehicle 2 increases.

The own vehicle position recognizer 42 recognizes the position of the vehicle 2. The own vehicle position recognizer 42 may recognize the position of the vehicle 2 based on the GNSS signal received by the GNSS receiver 21.

The acceleration detector 43 detects the acceleration of the vehicle 2 based on a signal from the acceleration sensor 17. The acceleration detector 43 may include the longitudinal acceleration, the lateral acceleration, and the vertical acceleration of the vehicle 2.

The collision predictor 44 determines a possibility of a collision between the obstacle and the vehicle 2. The collision predictor 44 determines that the possibility of the collision between the obstacle and the vehicle 2 is present when a time to collision (TTC) between the obstacle and the vehicle 2 is equal to or less than a collision threshold. The collision predictor 44 may determine the possibility of the collision for the obstacles, among those detected by the obstacle recognizer 41, whose distance from the vehicle 2 is within the prescribed value. The TTC may be calculated by dividing the distance between the obstacle and the vehicle 2 by the relative speed between the obstacle and the vehicle 2.

The road condition acquirer 45 acquires the unevenness of the road surface based on a signal from the acceleration sensor 17 or the stroke sensor 18. The unevenness of the road surface may be expressed, for example, as a value at multiple levels. When the unevenness of the road surface is large, the value may be increased. The road condition acquirer 45 may increase a value corresponding to the unevenness of the road surface according to the magnitude of the vertical acceleration. The road condition acquirer 45 may increase a value corresponding to the unevenness of the road surface according to the magnitude of the change in the stroke sensor 18. The road condition acquirer 45 may determine that the road surface is rough when the value corresponding to the unevenness of the road surface is equal to or greater than the prescribed rough road determination threshold.

The airbag controller 46 deploys the airbag 23A provided in the vehicle 2 when the acceleration is equal to or greater than the deployment threshold. The airbag controller 46 transmits the electric signal to the inflator 23B of the airbag unit 23 when the acceleration is equal to or more than the deployment threshold. The inflator 23B receives the electric signal from the airbag controller 46 and generates inflation gas to inflate the airbag 23A. The acceleration may be the longitudinal acceleration, the lateral acceleration, or the vertical acceleration of the vehicle 2.

The airbag controller 46 lowers the deployment threshold when a time period during which the obstacle recognizer 41 continuously detects the obstacle is equal to or longer than the capture threshold and the collision predictor 44 determines that the possibility of the collision between the obstacle and the vehicle 2 is present. That is, when an obstacle that is continuously detected by the obstacle recognizer 41 for a time period equal to or longer than the detection threshold has a possibility of colliding with the vehicle 2, the airbag controller 46 lowers the deployment threshold. The obstacle that is continuously detected by the obstacle recognizer 41 for the time period equal to or longer than the capture threshold is estimated to be the actually existing obstacle, not the ghost. By lowering the deployment threshold, the acceleration reaches or exceeds the deployment threshold at a lower acceleration, so that the airbag 23A is deployed earlier.

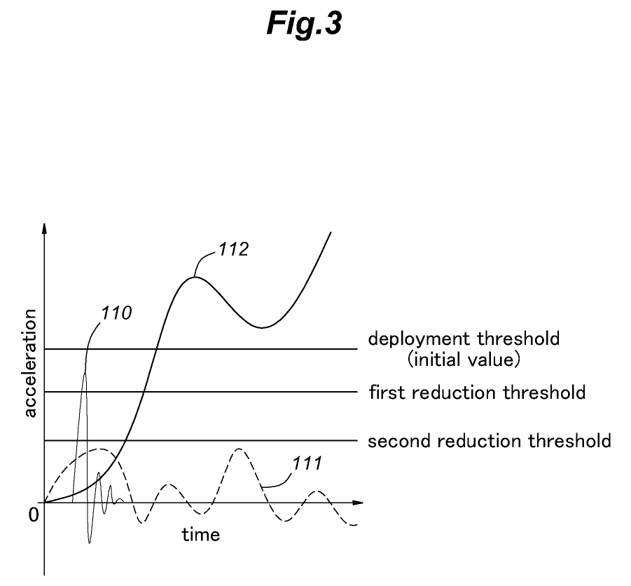

When the time period during which the obstacle recognizer 41 continuously detects the obstacle is equal to or longer than the capture threshold and the collision predictor 44 determines that the possibility of the collision between the obstacle and the vehicle 2 is present, the airbag controller 46 may lower the deployment threshold by a greater amount as the time period during which the obstacle recognizer 41 continuously detects the obstacle becomes longer. The longer the acquisition time, the greater the probability that the obstacle actually exists. That is, the longer the acquisition time, the lower the probability that the obstacle is the ghost. The acquisition time can be considered as a value corresponding to the probability that the obstacle actually exists. For example, as shown in FIG. 3, when the capture time is equal to or longer than the capture threshold and less than a first threshold, the airbag controller 46 may set a first reduction threshold for the deployment threshold. When the capture time is equal to or longer than the first threshold, the airbag controller 46 may set a second reduction threshold for the deployment threshold. The first determination value is set to a time period longer than the capture threshold. The first reduction threshold is set to a value lower than the initial value, and the second reduction threshold is set to a value lower than the first reduction threshold. The initial value is set higher than the maximum value of an acceleration 110 that occurs when the door of the vehicle 2 is closed. The first reduction threshold is set lower than the maximum value of the acceleration that occurs when the door of the vehicle 2 is closed. The first and second reduction thresholds may be set to values greater than a vertical acceleration 111 applied to the vehicle 2 when traveling on a rough road. By changing the deployment threshold from the initial value to the first reduction threshold or the second reduction threshold, an acceleration 112 caused by a collision reaches or exceeds the deployment threshold earlier.

When the unevenness of the road surface detected by the road condition acquirer 45 is large, the airbag controller 46 may maintain the deployment threshold even if the time period during which the obstacle recognizer 41 continuously detects the obstacle is equal to or longer than the capture threshold and the collision predictor 44 determines that the possibility of the collision between the obstacle and the vehicle 2 is present. According to this aspect, when the unevenness of the road surface is large, lowering the deployment threshold may cause the acceleration to exceed the deployment threshold due to vertical acceleration caused by the unevenness of the road surface, thereby possibly resulting in deployment of the airbag 23A. Accordingly, in such a situation, by prohibiting the lowering of the deployment threshold, it is possible to suppress the malfunction of the airbag 23A.

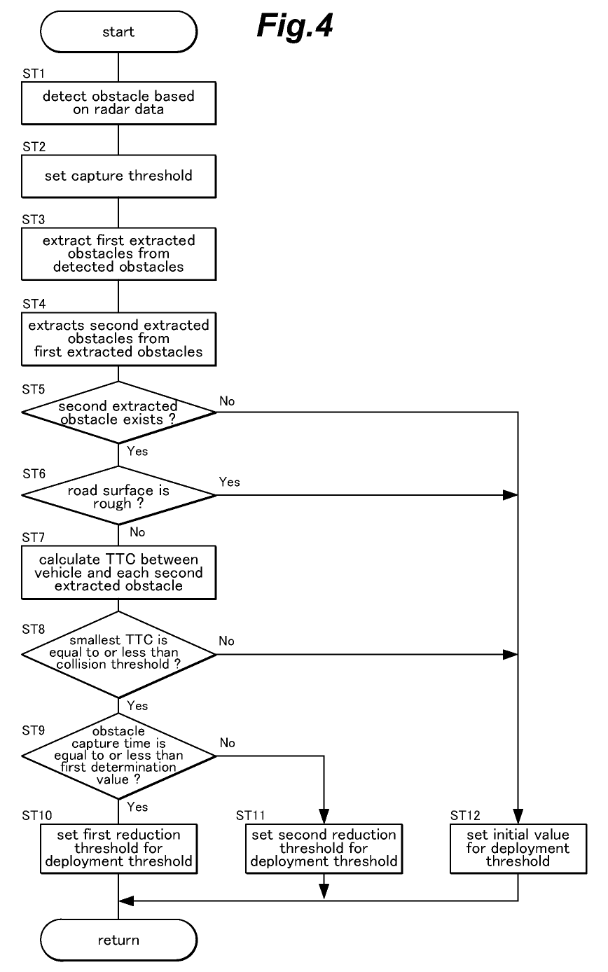

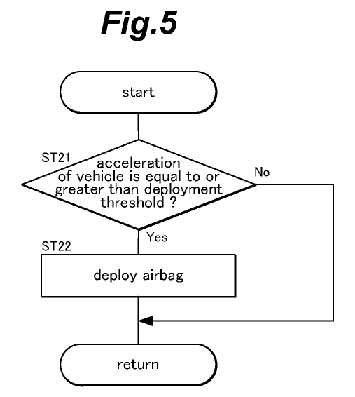

Next, the vehicle control method executed by the vehicle control system 1 will be described with reference to FIGS. 4 and 5. FIG. 4 is a flowchart showing a procedure for setting the deployment threshold. The vehicle control system 1 repeatedly executes the procedure for setting the deployment threshold at the prescribed time intervals. First, the vehicle control system 1 detects the obstacle based on the radar data acquired from the radar 11 (ST1). The number of detected obstacles may be zero, or one or more.

Next, the vehicle control system 1 sets the capture threshold based on the speed of the vehicle 2 (ST2). The capture threshold may be lowered as the speed of the vehicle 2 increases. The vehicle control system 1 may set the capture threshold corresponding to the speed of the vehicle 2 using a map in which the relationship between the speed of the vehicle 2 and the capture threshold is predetermined.

Next, the vehicle control system 1 extracts, as first extracted obstacles, among the detected obstacles, the obstacles whose capture time is equal to or longer than the capture threshold (ST3). The first extracted obstacles are highly likely to actually exist and not ghosts.

Next, the vehicle control system 1 extracts, as second extracted obstacles, among the first extracted obstacles, the obstacles whose distance from the vehicle 2 is equal to or less than the prescribed value (ST4). Next, the vehicle control system 1 determines whether the second extracted obstacles exist (ST5).

If the second extracted obstacles exist (ST5: Yes), the vehicle control system 1 determines whether the road surface on which the vehicle 2 is traveling is rough (ST6). The vehicle control system 1 acquires the unevenness of the road surface based on the vertical acceleration of the vehicle 2, and determines that the road surface is rough when the value of the unevenness of the road surface is equal to or greater than a rough road determination value.

When the road surface is not rough (ST6: No), the vehicle control system 1 calculates the TTC between the vehicle 2 and each of the second extracted obstacles (ST7).

Next, the vehicle control system 1 determines whether the smallest value among the calculated TTC is equal to or less than the collision threshold (ST8).

If the TTC is equal to or less than the collision threshold (ST8: Yes), the vehicle control system 1 determines whether the capture time of the obstacle is less than the first determination value (ST9). If the capture time of the obstacle is less than the first determination value (ST9: Yes), the vehicle control system 1 sets the first reduction threshold for the deployment threshold (ST10). If the acquisition time of the obstacle is equal to or longer than the first determination value (ST9: No), the vehicle control system 1 sets the second reduction threshold for the deployment threshold (ST11).

When the second extracted obstacle does not exist (ST5: No), when the road surface is rough (ST6: Yes), or when the TTC is greater than the collision threshold (ST8: No), the vehicle control system 1 sets the initial value for the deployment threshold (ST12).

FIG. 5 is a flowchart showing a procedure for controlling the deployment of the airbag 23A. The vehicle control system 1 repeats the procedure for controlling the deployment of the airbag 23A in FIG. 5 at the prescribed time intervals. The vehicle control system 1 determines whether the acceleration of the vehicle 2 acquired by the acceleration sensor 17 is equal to or greater than a deployment threshold (ST21). The acceleration of the vehicle 2 may be the longitudinal acceleration, the lateral acceleration, or the vertical acceleration. The deployment threshold is set based on the procedure for setting the deployment threshold of FIG. 4.

When the acceleration of the vehicle 2 is equal to or greater than the deployment threshold (ST21: Yes), the vehicle control system 1 deploys the airbag 23A (ST22). More specifically, the vehicle control system 1 outputs the electric signal to the inflator 23B of the airbag unit 23, causing the inflator 23B to generate inflation gas.

When the acceleration of the vehicle 2 is less than the deployment threshold (ST21: No), the process proceeds to return.

According to the above embodiment, when the obstacle detected by the radar 11 is highly likely to be the ghost, the deployment threshold is not lowered. Therefore, the deployment of the airbag 23A at an incorrect timing due to the acceleration caused by the unevenness of the road surface is prevented. On the other hand, when the obstacle detected by the radar 11 is highly likely to actually exist and there is a possibility of a collision, the deployment threshold is lowered, causing the airbag 23A to deploy early.

The embodiment is not limited to the above configuration and can be widely modified and implemented. For example, in the flowchart of FIG. 4, the determination of whether the road surface is rough in step ST6 may be omitted. Further, the process of setting the capture threshold based on the speed of the vehicle 2 in step ST2 may be omitted, and a preset fixed value may be used as the capture threshold.

The above embodiment may be described as follows:

One embodiment is a vehicle control system 1 including: an obstacle recognizer 41 configured to recognize an obstacle around a vehicle 2 based on a signal from a radar 11; an acceleration detector 43 configured to detect acceleration of the vehicle 2 based on a signal from an acceleration sensor 17; a collision predictor 44 configured to determine a possibility of collision between the obstacle and the vehicle 2; and an airbag controller 46 configured to deploy an airbag 23A provided in the vehicle 2 when the acceleration is equal to or greater than a deployment threshold, and the airbag controller 46 lowers the deployment threshold when a time period during which the obstacle recognizer 41 continuously detects the obstacle is equal to or longer than a capture threshold and the collision predictor 44 determines that the possibility of the collision between the obstacle and the vehicle 2 is present.

According to this aspect, it is possible to provide the vehicle control system 1 that can deploy the airbag 23A at an appropriate timing. When the obstacle detected by the radar 11 is highly likely to be the ghost, the deployment threshold is not lowered. Therefore, the deployment of the airbag 23A at an incorrect timing due to the acceleration caused by the unevenness of the road surface is prevented. On the other hand, when the obstacle detected by the radar 11 is highly likely to actually exist and there is a possibility of a collision, the deployment threshold is lowered, causing the airbag 23A to deploy early.

In the above embodiment, preferably, the collision predictor 44 determines that the possibility of the collision between the obstacle and the vehicle 2 is present when a time to collision (TTC) between the obstacle and the vehicle 2 is equal to or less than a collision threshold.

According to this aspect, the possibility of the collision between the obstacle and the vehicle 2 can be determined based on the TTC.

In the above embodiment, preferably, the obstacle recognizer 41 is configured to lower the capture threshold as a speed of the obstacle or a speed of the vehicle 2 increases.

According to this aspect, in a situation where the speed of the obstacle or the vehicle 2 is high and higher safety is required, the obstacle is determined to be an actually existing obstacle at an earlier timing. This further improves safety.

In the above embodiment, preferably, when the time period during which the obstacle recognizer 41 continuously detects the obstacle is equal to or longer than the capture threshold and the collision predictor 44 determines that the possibility of the collision between the obstacle and the vehicle 2 is present, the airbag controller 46 lowers the deployment threshold by a greater amount as the time period during which the obstacle recognizer 41 continuously detects the obstacle becomes longer.

According to this aspect, the greater the probability that the obstacle actually exists, the more the deployment threshold can be lowered, thereby enabling a quicker response to a collision.

In the above embodiment, preferably, the vehicle control system 1 further includes a road condition acquirer 45 configured to acquire an unevenness of a road surface based on a signal from a sensor, and when the unevenness of the road surface detected by the road condition acquirer 45 is large, the airbag controller 46 maintains the deployment threshold even if the time period during which the obstacle recognizer 41 continuously detects the obstacle is equal to or longer than the capture threshold and the collision predictor 44 determines that the possibility of the collision between the obstacle and the vehicle 2 is present.

According to this aspect, when the unevenness of the road surface is large, the lowering of the deployment threshold can be prohibited. Therefore, the deployment of the airbag 23A due to the acceleration caused by the unevenness of the road surface is prevented.

Another embodiment is a vehicle control method executed by a computer, the method including: recognizing an obstacle around a vehicle 2 based on a signal from a radar 11; detecting acceleration of the vehicle 2 based on a signal from an acceleration sensor 17; determining a possibility of collision between the obstacle and the vehicle 2; deploying an airbag 23A provided in the vehicle 2 when the acceleration is equal to or greater than a deployment threshold; and lowering the deployment threshold when a time period during which the obstacle is continuously detected is equal to or longer than a capture threshold and the possibility of the collision between the obstacle and the vehicle 2 is determined to be present.

According to this aspect, it is possible to provide a vehicle control method that can deploy the airbag 23A at an appropriate timing.

Another embodiment is a non-transitory computer-readable storage medium comprising a control program, wherein the control program, when executed by a computer, executes a vehicle control method, including: recognizing an obstacle around a vehicle 2 based on a signal from a radar 11; detecting acceleration of the vehicle 2 based on a signal from an acceleration sensor 17; determining a possibility of collision between the obstacle and the vehicle 2; deploying an airbag 23A provided in the vehicle 2 when the acceleration is equal to or greater than a deployment threshold; and lowering the deployment threshold when a time period during which the obstacle is continuously detected is equal to or longer than a capture threshold and the possibility of the collision between the obstacle and the vehicle 2 is determined to be present.

According to this aspect, it is possible to provide a storage medium for executing the vehicle control method that can deploy the airbag 23A at an appropriate timing.

1. A vehicle control system comprising:
an obstacle recognizer configured to recognize an obstacle around a vehicle based on a signal from a radar;
an acceleration detector configured to detect acceleration of the vehicle based on a signal from an acceleration sensor;
a collision predictor configured to determine a possibility of collision between the obstacle and the vehicle; and
an airbag controller configured to deploy an airbag provided in the vehicle when the acceleration is equal to or greater than a deployment threshold, wherein
the airbag controller lowers the deployment threshold when a time period during which the obstacle recognizer continuously detects the obstacle is equal to or longer than a capture threshold and the collision predictor determines that the possibility of the collision between the obstacle and the vehicle is present.

2. The vehicle control system according to claim 1, wherein the collision predictor determines that the possibility of the collision between the obstacle and the vehicle is present when a time to collision between the obstacle and the vehicle is equal to or less than a collision threshold.

3. The vehicle control system according to claim 1, wherein the obstacle recognizer is configured to lower the capture threshold as a speed of the obstacle or a speed of the vehicle increases.

4. The vehicle control system according to claim 1, wherein, when the time period during which the obstacle recognizer continuously detects the obstacle is equal to or longer than the capture threshold and the collision predictor determines that the possibility of the collision between the obstacle and the vehicle is present, the airbag controller lowers the deployment threshold by a greater amount as the time period during which the obstacle recognizer continuously detects the obstacle becomes longer.

5. The vehicle control system according to claim 1, further comprising a road condition acquirer configured to acquire an unevenness of a road surface based on a signal from a sensor, wherein
when the unevenness of the road surface detected by the road condition acquirer is large, the airbag controller maintains the deployment threshold even if the time period during which the obstacle recognizer continuously detects the obstacle is equal to or longer than the capture threshold and the collision predictor determines that the possibility of the collision between the obstacle and the vehicle is present.

6. A vehicle control method executed by a computer, the method comprising:
recognizing an obstacle around a vehicle based on a signal from a radar;
detecting acceleration of the vehicle based on a signal from an acceleration sensor;
determining a possibility of collision between the obstacle and the vehicle;
deploying an airbag provided in the vehicle when the acceleration is equal to or greater than a deployment threshold; and
lowering the deployment threshold when a time period during which the obstacle is continuously detected is equal to or longer than a capture threshold and the possibility of the collision between the obstacle and the vehicle is determined to be present.

7. A non-transitory computer-readable storage medium comprising a control program, wherein the control program, when executed by a computer, executes a vehicle control method, comprising:
recognizing an obstacle around a vehicle based on a signal from a radar;
detecting acceleration of the vehicle based on a signal from an acceleration sensor;
determining a possibility of collision between the obstacle and the vehicle;
deploying an airbag provided in the vehicle when the acceleration is equal to or greater than a deployment threshold; and
lowering the deployment threshold when a time period during which the obstacle is continuously detected is equal to or longer than a capture threshold and the possibility of the collision between the obstacle and the vehicle is determined to be present.
